(19) United States
(12) Patent Application Publication
(10) Pub. No.: US 2023/0061609 A1
(43) Pub. Date: Mar. 2, 2023

(54) ELECTRICAL DUAL SURFACE CONDUCTOR LUG

(71) Applicant: Hamilton Sundstrand Corporation, Charlotte, NC (US)

(72) Inventors: Nhia Yang, Roscoe, IL (US); Francis C. Belisle, Beloit, WI (US)

(21) Appl. No.: 17/411,935

(22) Filed: Aug. 25, 2021

(51) Int. Cl. H01R 13/512

(52) U.S. Cl. CPC H01R 13/512; H01R 2201/26

(57) ABSTRACT

A connector system includes a barrel and a lug connector arranged at an end of the barrel. The lug connector has a first contact and a second contact separated by a clearance. A substrate is arranged within the clearance and is electrically and mechanically coupled to the lug connector over an electrical conduction surface area. The electrical conduction surface area extends over a portion of both the first contact and the second contact.

### BACKGROUND

Exemplary embodiments of the present disclosure pertain to the art of electrical connections, and more particularly, to a lug connector.

Hybrid vehicles that are powered by both electrical power and gas powered engines are becoming more common. The electrical motors and generators that are being incorporated into the propulsion system of such vehicles may increase the amperage and/or voltage applied to an electrical joint.

### BRIEF DESCRIPTION

According to an embodiment, a connector system includes a barrel and a lug connector arranged at an end of the barrel. The lug connector has a first contact and a second contact separated by a clearance. A substrate is arranged within the clearance and is electrically and mechanically coupled to the lug connector over an electrical conduction surface area. The electrical conduction surface area extends over a portion of both the first contact and the second contact.

In addition to one or more of the features described above, or as an alternative to any of the foregoing embodiments the first contact and the second contact are equidistantly spaced from a central axis of the barrel.

In addition to one or more of the features described above, or as an alternative to any of the foregoing embodiments both the first contact and the second contact are oriented substantially parallel to a central axis of the barrel.

In addition to one or more of the features described above, or as an alternative to any of the foregoing embodiments the lug connector has a C-shape or U-shape.

In addition to one or more of the features described above, or as an alternative to any of the foregoing embodiments at least one of the first contact and the second contact is oriented at a non-parallel angle to a central axis of the barrel.

In addition to one or more of the features described above, or as an alternative to any of the foregoing embodiments the first contact and the second contact are substantially identical.

In addition to one or more of the features described above, or as an alternative to any of the foregoing embodiments the first contact and the second contact are rectangular in shape.

In addition to one or more of the features described above, or as an alternative to any of the foregoing embodiments the at least one first connection hole includes at least two first connection holes, and the at least one second connection hole includes at least two second connection holes.

In addition to one or more of the features described above, or as an alternative to any of the foregoing embodiments the at least two first connection holes are aligned along an axis oriented parallel to a central axis of the barrel.

In addition to one or more of the features described above, or as an alternative to any of the foregoing embodiments the lug connector is affixed to the end of the barrel.

In addition to one or more of the features described above, or as an alternative to any of the foregoing embodiments the lug connector is integrally formed with the end of the barrel.

In addition to one or more of the features described above, or as an alternative to any of the foregoing embodiments at least one relief cut is formed in the barrel at an interface between the lug connector and the barrel.

In addition to one or more of the features described above, or as an alternative to any of the foregoing embodiments both the first contact and the second contact has an inwardly facing surface facing towards the clearance, the electrical conduction surface area extending over at least part of the inwardly facing surface of both the first contact and the second contact.

In addition to one or more of the features described above, or as an alternative to any of the foregoing embodiments the substrate is a bus bar.

In addition to one or more of the features described above, or as an alternative to any of the foregoing embodiments the connector system is part of an electrical system of an aircraft.

Additional features and advantages are realized through the techniques of the embodiments herein. Other embodiments are described in detail herein and are considered a part of the claims. For a better understanding of the embodiments with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 is a perspective view of a connector system according to an embodiment;

FIG. 2 is a side view of a connector system according to an embodiment;

FIG. 3 is a perspective view of another connector system according to an embodiment;

FIG. 4 is a side view of the connector system of FIG. 3 according to an embodiment; and

FIG. 5 is an example view of a crimp barrel during formation of a lug connector according to an embodiment.

### DETAILED DESCRIPTION

A detailed description of one or more embodiments of the disclosed apparatus and method are presented herein by way of exemplification and not limitation with reference to the FIGS.

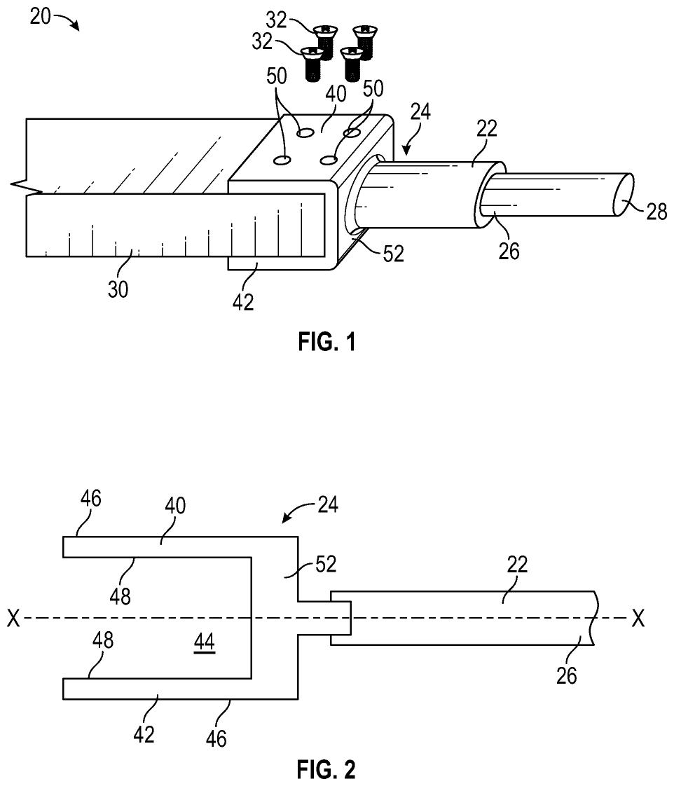

With reference now to FIG. 1, an example of a connector system 20 for use in an electrical system of a vehicle, such as an aircraft for example, is illustrated. The connector system 20 includes a tube or barrel 22 having a lug connector 24 disposed at an end 26 thereof. In an embodiment, an end 26 of the barrel 22 is generally hollow or open end such that a cable or wire (28) is receivable therein. The barrel 22 may be crimped or swaged to retain the cable 28 and create a low-resistance joint. The lug connector 24 is configured to be mechanically and electrically connected to an interface substrate 30 to transfer power between the cable 28 and the substrate 30. In the illustrated, non-limiting embodiment, the substrate 30 is a bus bar and is connected to the lug connector 24 via one or more fasteners 32, such as screws for example. However, other types of substrates, such as a terminal or component for example, and any suitable mechanism for coupling the substrate to the lug connector are also within the scope of the disclosure.

With continued reference to FIG. 1 and further reference to FIGS. 2-4, the lug connector 24 of the connector system 20 is illustrated in more detail. In the illustrated, non-limiting embodiment, the lug connector 24 has a plurality of contacts including a first contact 40 and a second contact 42 separated from the first contact 40 such that a clearance 44 is defined therebetween. The first contact 40 and the second contact 42 may have substantially identical configurations, as shown, or alternatively, may have different configurations. In the illustrated, non-limiting embodiment, each of the first and second contacts 40, 42 is generally rectangular in shape. However, it should be understood that a contact 40, 42 having any suitable shape, such as a ring shape for example, is within the scope of the disclosure. Further, in an embodiment, the first contact 40 and the second contact 42 are arranged parallel to one another, and parallel to the central longitudinal axis X of the barrel 22. In other embodiments, the first contact and the second contact may be arranged at a non-parallel angle to one another and/or to the axis X of the barrel 22. Regardless of whether the contacts are oriented parallel to or at an angle to the central axis X, the contacts 40, 42 may be equidistantly spaced from the axis X as shown, or alternatively, may be arranged at different distances from the axis X.

Each contacts 40, 42 of the lug connector 24 includes an outwardly facing surface 46 and an inwardly facing surface 48, opposite the outwardly facing surface 46. The inwardly facing surfaces 48 of the first and second contacts 40, 42 are arranged closest to one another. These inwardly and outwardly facing surfaces 46, 48 are formed from a galvanic or conductive material, such as metal for example. Although the inwardly and outwardly facing surfaces 46, 48 are shown having a planar configuration intended to facilitate contact with a substrate 30, embodiments where one or both of the outwardly facing surface 46 and the inwardly facing surface 48 of either contact 40, 42 is contoured in a manner complementary to a corresponding substrate 30 are also contemplated herein.

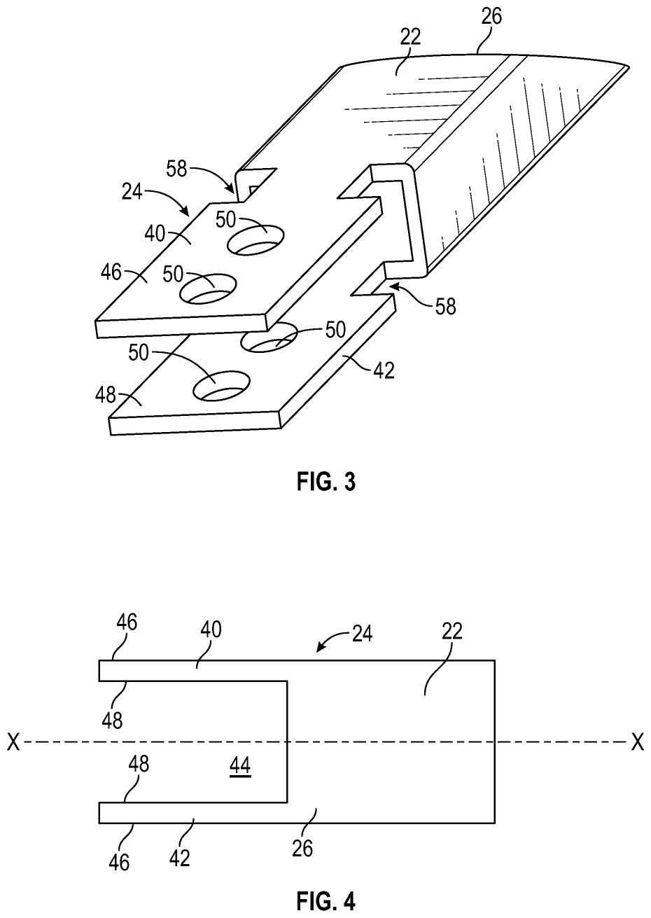

In an embodiment, each contact 40, 42 is elongated such that a plurality of connection holes 50 are formed therein. The connection holes 50 are through holes that extend from the outwardly facing surface 46 to the inwardly facing surface 48. Although two first connection holes 50 are shown as being formed in the first contact and two second connection holes 50 are illustrated as being formed in the contact 40, 42 in FIG. 3, it should be understood that embodiments having more than two connection holes 50, such as three connection holes, four connection holes (see FIG. 1), five connection holes or more for example, are also contemplated herein. In addition, embodiments where a contact 40, 42 has only a single connection hole 50 formed therein is also within the scope of the disclosure. Further, the connection holes 50 of each of the contacts 40, 42 shown in the illustrated, non-limiting embodiment are aligned with one another along the longitudinal axis of the contacts 40, 42. However, embodiments where the connection holes 50 are arranged in another configuration about the contacts 40, 42 are also contemplated herein. In addition, although the first and second contacts 40, 42 are illustrated as having the same number of connection holes 50 having the same configuration (size, shape, and/or location relative to the contacts 40, 42) embodiments where a configuration of the one or more connection holes 50 formed in the first contact 40 is different from the configuration of the one or more connection holes 50 formed in the second contact 42 are also contemplated herein. Although only two contacts 40, 42 are illustrated and described herein, it should be understood that embodiments having more than two contacts are also within the scope of the disclosure.

With reference again to FIGS. 1 and 2, the plurality of contacts 40, 42 may be integrally formed with one another. In the illustrated, non-limiting embodiment, a piece or connector 52 extends between an end of each of the first contact 40 and the second contact 42 such that the lug connector 24 may have a U-shape or a C-shape for example. In such embodiments, the lug connector 24 may be mechanically and electrically attached to an end 26 of the barrel 22 via any suitable process, including but not limited to soldering, welding, brazing, and crimping for example.

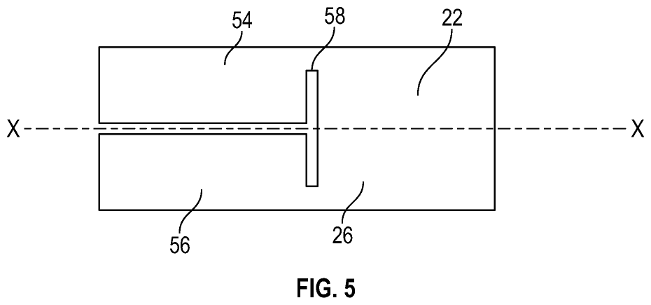

In other embodiments, best shown in FIGS. 3 and 4, the plurality of contacts 40, 42 may be integrally formed with and extend directly from the barrel 22. For example, the first and second contacts 40, 42 may be formed by cutting the end 26 of the barrel 22 along a plane containing the axis X (see FIG. 5). A first portion 54 of the barrel 22 formed by the cut may be flattened via a standard crimping or stamping process to form the first contact 40, and similarly, a second portion 56 of the barrel 22 formed by the cut may be flattened to form the second contact 42. One or more relief cuts 58 may be formed at the interface between the portion of the barrel 22 that forms the contacts 40, 42 and the remainder of the barrel 22 to facilitate the flattening thereof.

With continued reference to FIG. 1, a lug connector 24 having a first and second contact 40, 42 as described herein may be configured to receive a substrate 30 within the clearance 44 defined between the inwardly facing surfaces 48 of the first and second contacts 40, 42. In such embodiments, the substrate 30 is arranged in direct contact with the inwardly facing surfaces 48 of both the first contact 40 and the second contact 42. However, in other embodiments, two different substrates 30 may be arranged in contact with and coupled to an inwardly or outwardly facing surface 46, 48 of the first and second contacts 40, 42, respectively.

The lug connector 24 having two contacts 40, 42 and therefore two surfaces configured to contact a substrate 30 has an increased contact surface area with a substrate 30 compared to existing lug connectors, while maintaining a similar size envelope. By increasing this electrical conduction surface area between the substrate 30 and the lug connector 24, the thermal losses and voltage drop at the lug connector are reduced and the heat conduction is increased, thereby creating a thermally cooler electrical joint.

Aspects of the embodiments are described herein with reference to flowchart illustrations, schematics, and/or block diagrams of methods, apparatus, and/or systems according to embodiments. Further, the descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of embodiments herein. For instance, the steps may be performed in a differing order or steps may be added, deleted or modified. All of these variations are considered a part of the claims.

While the preferred embodiment has been described, it will be understood that those skilled in the art, both now and in the future, may make various improvements and enhancements which fall within the scope of the claims which follow. These claims should be construed to maintain the proper protection.

What is claimed is:

1. A connector system comprising:
a barrel;
a lug connector arranged at an end of the barrel, the lug connector having a first contact and a second contact separated by a clearance; and
a substrate arranged within the clearance, wherein the substrate is electrically and mechanically coupled to the lug connector over an electrical conduction surface area, the electrical conduction surface area extending over a portion of both the first contact and the second contact.

2. The connector system of claim 1, wherein the first contact and the second contact are equidistantly spaced from a central axis of the barrel.

3. The connector system of claim 1, wherein both the first contact and the second contact are oriented substantially parallel to a central axis of the barrel.

4. The connector system of claim 3, wherein the lug connector has a C-shape or U-shape.

5. The connector system of claim 1, wherein at least one of the first contact and the second contact is oriented at a non-parallel angle to a central axis of the barrel.

6. The connector system of claim 1, wherein the first contact and the second contact are substantially identical.

7. The connector system of claim 1, wherein the first contact and the second contact are rectangular in shape.

8. The connector system of claim 1, wherein the at least one first connection hole includes at least two first connection holes, and the at least one second connection hole includes at least two second connection holes.

9. The connector system of claim 1, wherein the at least two first connection holes are aligned along an axis oriented parallel to a central axis of the barrel.

10. The connector system of claim 1, wherein the lug connector is affixed to the end of the barrel.

11. The connector system of claim 1, wherein the lug connector is integrally formed with the end of the barrel.

12. The connector system of claim 11, wherein at least one relief cut is formed in the barrel at an interface between the lug connector and the barrel.

13. The connector system of claim 1, wherein both the first contact and the second contact has an inwardly facing surface facing towards the clearance, the electrical conduction surface area extending over at least part of the inwardly facing surface of both the first contact and the second contact.

14. The connector system of claim 13, wherein the substrate is a bus bar.

15. The connector system of claim 13, wherein the connector system is part of an electrical system of an aircraft.
